(19) United States
(12) Patent Application Publication
(10) Pub. No.: US 2022/0414695 A1
(43) Pub. Date: Dec. 29, 2022

(54) SYSTEMS AND METHODS TO PROVIDE ACTIONABLE INSIGHTS TO ONLINE ENVIRONMENT PROVIDERS BASED ON AN ONLINE ENVIRONMENT AND PSYCHOLOGICAL ATTRIBUTES OF USERS

(71) Applicant: Solsten, Inc., St. Paul, MN (US)

(72) Inventors: Joseph Jack Schaeppi, Maple Grove, MN (US); Lynn Danielle Francoise Bergmann, Berlin (DE); Lloyd William West, Berlin (DE)

(21) Appl. No.: 17/361,261

(22) Filed: Jun. 28, 2021

(51) Int. Cl. G06Q 30/02; G06Q 50/00; G06Q 10/06

(52) U.S. Cl. CPC G06Q 30/0204; G06Q 30/0201; G06Q 50/01; G06Q 30/0206; G06Q 10/06375

(57) ABSTRACT

Systems and methods to provide actionable insights to online environment providers based on an online environment and psychological attributes of users are disclosed. Exemplary implementations may: obtain cluster information for individual clusters; obtain environment information characterizing an online environment of the individual clusters; obtain performance information that characterizes performances of user behavior patterns within the online environment by the users of individual ones of the subclusters; determine response actions for implementation by a provider server of the online environment based on the individual subclusters, the performance information, and the environment information; and transmit the response actions to the provider server for implementation.

### FIELD OF THE DISCLOSURE

The present disclosure relates to systems and methods to provide actionable insights to online environment providers based on an online environment and psychological attributes of users.

### BACKGROUND

Providers of online environments may not know how to revise or improve their online environment, have insight on how to revise their online environment, or may have to spent significant time and resources to determine such. Additionally, revisions are often made throughout the online environment for all users and are not adapted for individual users, clusters of users, or subclusters of users.

### SUMMARY

One aspect of the present disclosure relates to a system configured to facilitate providers of online environments with actionable insights to improve user experiences with the online environments. That is, the providers of the online environments may be transmitted response actions for implementation that have been determined based on clusters of users, subclusters of the clusters, the online environment itself, and performances of user behavior patterns by the users within the online environment. The response actions may facilitate an increase in engagement by the users with the online environment, an increase in engagement with other ones of the users, improving utilization of the online environment by the users, reducing excessive engagement or use of the online environment, and/or other improvements. As such, the providers may be alleviated from analyzing user behavior patterns in conjunction with the subclusters within the online environment and researching and/or developing the response actions tailored to the subclusters to provide improved user experiences.

One aspect of the present disclosure relates to a system configured to provide actionable insights to online environment providers based on an online environment and psychological attributes of users. The system may include one or more hardware processors configured by machine-readable instructions. Machine-readable instructions may include one or more instruction components. The instruction components may include one or more of cluster obtaining component, environment obtaining component, performance obtaining component, response action determination component, and/or other instruction components.

The cluster obtaining component may be configured to obtain cluster information for individual clusters. The cluster information may characterize the similar psychological parameter values to psychological parameters of users in the same cluster. The cluster information may include subclusters of the users within the individual clusters that have one or more particularly similar psychological parameter values to particular ones of the psychological parameters.

The environment obtaining component may be configured to obtain environment information characterizing an online environment of the individual clusters.

The performance obtaining component may be configured to obtain performance information that characterizes performances of user behavior patterns within the online environment by the users of individual ones of the subclusters.

The response action determination component may be configured to determine response actions for implementation by a provider server of the online environment based on the individual subclusters, the performance information, the environment information, and/or other information. The response action determination component may be configured to transmit the response actions and/or other information to the provider server for implementation.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to provide actionable insights to online environment providers based on an online environment and psychological attributes of users, in accordance with one or more implementations.

FIG. 2 illustrates a method to provide actionable insights to online environment providers based on an online environment and psychological attributes of users, in accordance with one or more implementations.

FIG. 3 illustrates an example implementation of the system configured to provide actionable insights to online environment providers based on an online environment and psychological attributes of users, in accordance with one or more implementations.

### DETAILED DESCRIPTION

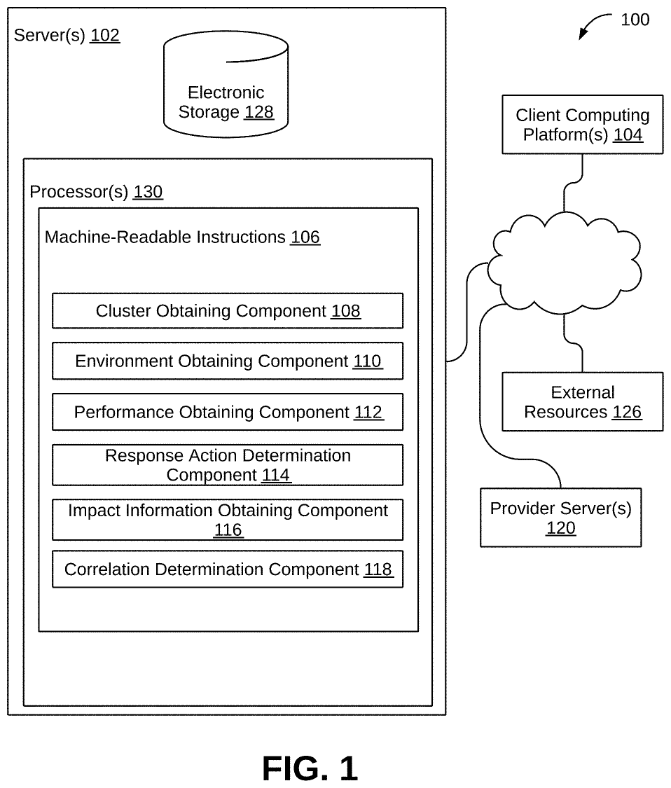

FIG. 1 illustrates a system 100 configured to provide actionable insights to online environment providers based on an online environment and psychological attributes of users, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Provider server(s) 120 may refer to one or more servers that provide individual online environments. Providing the individual online environments may include effectuating presentation of graphical user interface that includes various virtual content, receiving input from the users of the individual online environments, providing information via the graphical user interface (e.g., in response to the input, response actions), and/or other operations that facilitate providing the online environment. In some implementations, provider server(s) 120 may be external to server(s) 102. In some implementations, provider server(s) 120 may be the same as server(s) 102. By way of non-limiting example, provider server(s) 120 may include one or more of an application server, a web server, a file server, a database server, a virtual server, a management server, a game server, and/or other servers. By way of non-limiting example, a dating service online environment may be provided by the application server, a database server, a game server, and/or other servers. By way of non-limiting example, a shopping online environment may be provided by the application server, a database server, a management server, and/or other servers.

Server(s) 102 may be configured by machine-readable instructions 106. Machine-readable instructions 106 may include one or more instruction components. The instruction components may include computer program components. The instruction components may include one or more of cluster obtaining component 108, environment obtaining component 110, performance obtaining component 112, response action determination component 114, impact information obtaining component 116, correlation determination component 118, and/or other instruction components.

Cluster obtaining component 108 may be configured to obtain cluster information for individual clusters and/or other information. In some implementations, the cluster information may be stored in electronic storage 128, a cloud storage, storage of external server(s), and/or other storage. In some implementations, cluster obtaining component 108 may be configured to obtain the cluster information from one or more of the various storage. In some implementations, the cluster information may be obtained from provider server(s) 120 of the individual online environments.

The cluster information may characterize the similar psychological parameter values to psychological parameters of users in the same cluster. Clusters of users may refer to users that have been assigned to an individual cluster based on similarities in their psychological parameter values, performances of user behavior patterns, and/or other information. As used herein, identifying clusters of users, assigning users to clusters, or clustering users may refer to operations that congregate or group together the users that are more similar than other ones of the users as a result of the psychological parameter values, the performance of the user behavior patterns, and/or other obtained information. The clustering of users may be particularly based on information related to the users (i.e., the psychological parameter values, the performance of the user behavior patterns, and/or other information determined or obtained for the individual users) and without regard to pre-existing clusters. That is, given that one or more clusters of users exist, a new user need not be assigned to one of the pre-existing clusters unless the information related to the new user is most similar to the information of the users in one of the pre-existing clusters. In some implementations, the new user may be assigned to a newly identified cluster with other users that are the most similar to the new user based on the information related to those other users. In some implementations, users may be assigned to more than one cluster. The users may be assigned to clusters as described in co-pending U.S. application Ser. No. 16/854,660 entitled “SYSTEMS AND METHODS FOR ADAPTING USER EXPERIENCE IN A DIGITAL EXPERIENCE BASED ON PSYCHOLOGICAL ATTRIBUTES OF INDIVIDUAL USERS”, Attorney Docket No. 01TT-064001, the disclosure of which is incorporated by reference in its entirety herein and/or U.S. application Ser. No. 16/894,522 entitled “SYSTEMS AND METHODS TO CORRELATE USER BEHAVIOR PATTERNS WITHIN AN ONLINE GAME WITH PSYCHOLOGICAL ATTRIBUTES OF USERS”, Attorney Docket No. 01TT-064002.

The psychological parameter values may characterize, by way of non-limiting example, achievement motivation, motivation, personality inventory, cultural values, competitiveness, positive and negative affect before, during, and/or after engagement with the online game (i.e., emotions), communication style, personal values, daily routines/activities, life/gaming pain points, life/gaming hopes and aspirations, wellbeing, user experience, gaming/experience using time, subscription behavior, affinity information, personality, emotional style, goal orientation, goal commitment, ego and task orientation, relatedness, sense of community, social influence, social identity, group identification, we-identity, quality of life, satisfaction with life, work-related quality of life, mindfulness, happiness, emotional intelligence, self-awareness/internal awareness, external awareness, connectedness to nature, social connectedness, social bonding, perceived stress, depression, anxiety, decision-making style, thinking style, critical thinking, cognitive approach to learning, learning style, attributional style, internality-externality, stability-instability, global-specific, creativity, curiosity, playfulness, exploration, mental strength, grit, flourishing, gratitude, inspiration, spirituality, hedonism, materialism/material values, perceptions, sentiments, and/or other psychological parameters.

Achievement motivation may include compensatory effort, competitiveness, confidence in success, dominance, eagerness to learn, engagement, fearlessness, flexibility, flow, goal setting, independence, internality, persistence, preference in difficult tasks, pride in productivity, self-control, status orientation, ambition, self-assurance, and/or other psychological parameters. Motivation may include mastery, purpose, autonomy, and/or other psychological parameters.

Personality inventory may include neuroticism, openness, conscientiousness, extraversion, and agreeableness and/or other psychological parameters. Neuroticism may include anxiety, impulsiveness, vulnerability, and/or other psychological parameters. Openness may include fantasy, feelings/empathy, action, and/or other psychological parameters. Conscientiousness may include achievement striving, competence, self-discipline, and/or other psychological parameters. Extraversion may include warmth assertiveness, activity, and/or other psychological parameters. Agreeableness may include trust, altruism, modesty, and/or other psychological parameters.

Cultural values may include individualism, indulgence, long term orientation, masculinity, power distance, uncertainty avoidance, and/or other psychological parameters. Competitiveness may include avoidant, collaborative, competitive affectivity, dependent, dominant, general competitiveness, independent, personal enhancement, and/or other psychological parameters.

Positive and negative affect before, during, and/or after engaging in the online game may include hostility, joviality, negative emotions, positive emotions, sadness, self-assurance, and/or other psychological parameters. Communication style may include feeler, intuitor, sensor, thinker, and/or other psychological parameters.

Wellbeing may include social wellbeing, psychological wellbeing, physical wellbeing, physical activity, sleep, bounded reciprocity, resilience grit, and/or other psychological parameters.

Personality may include anger, hostility, depression, self-conscientiousness, excitement-seeking, positive emotions, gregariousness, ideas, values, aesthetics, tender-mindedness, straightforwardness, compliance, deliberation, order, dutifulness, and/or other psychological parameters.

Emotional style may include resilience, outlook, social intuition, self-awareness, sensitivity to context, attention, and/or other psychological parameters.

Goal orientation may include mastery approach/learning goal orientation, performance approach/performance goal orientation, performance avoid/avoidance goal orientation, and/or other psychological parameters.

Work-related quality of life may include structure, boundaries, focus, efficiency, information provision, communication, psychological support, stress at/from work, psychological safety, connectedness with team, motivation to work, adaptability, job/career satisfaction, control at work, home-work interface, general wellbeing, working conditions, and/or other psychological parameters.

Mindfulness may include observing, describing, acting with awareness, non-judgment, non-reactivity, and/or other psychological parameters.

Emotional intelligence may include emotion perception, emotion expression, emotion management, emotion regulation, impulse control, relationships, stress management, and/or other psychological parameters.

Social connectedness may include social connectedness, loneliness, membership self-esteem, private self-esteem, public self-esteem identity self-esteem, interdependent self, independent self, social avoidance, social distress, and/or other psychological parameters.

Decision-making style may include respected, confident, spontaneous, dependent, vigilant, avoidant, brooding, intuitive, anxious, and/or other psychological parameters.

Thinking style may include intuitive, experiential, analytical, rational, and/or other psychological parameters.

Cognitive approaches to learning may include avoidant, participative, competitive, collaborative, dependent, independent, and/or other psychological parameters.

Learning style may include visual (spatial), aural (auditory-musical), verbal (linguistic), physical (kinesthetic), logical (mathematical), social (interpersonal), solitary (intrapersonal), and/or other psychological parameters.

Mental strength may include tenacity, confidence, optimism, adaptability, self-awareness, reliability, responsibility, well-being, and/or other psychological parameters.

Flourishing may include positive emotion, engagement, relationships, meaning, accomplishment, health, loneliness, and/or other psychological parameters.

By way of non-limiting example, the psychological parameter values of the psychological parameters may be a number score on a predetermined range unique to each psychological parameter, a letter score, and/or other type of value than may characterize a particular user as whole.

Individual clusters may include subclusters of the users within the individual clusters that have one or more particularly similar psychological parameter values to particular ones of the psychological parameters. The cluster information may include the subclusters of the users within the individual clusters. Particular similar psychological parameter values may include psychological parameter values that are within a particular range (e.g., with a 3 points), exactly the same, a specific amount of psychological parameters with psychological parameter values that are within the particular range or exactly the same, and/or other particular similarities. The range and/or the specific amount may be predefined by system 100 or may be defined and modifiable by an administrator of system 100 and/or provider server(s) 120.

Environment obtaining component 110 may be configured to obtain environment information characterizing the individual online environments of the individual clusters. In some implementations, environment obtaining component 110 may be configured to obtain the environment information from one or more of the various storage. In some implementations, the environment information may be obtained from provider server(s) 120 of the respective online environments. By way of non-limiting example, the environment information may include one or more of a type of online environment, an objective of the online environment, rules for the online environment, characters (e.g., player-controlled, non-player-controlled), virtual items, content, a reward system, tasks, quests, assignments, missions, levels, chapters, mini-games, virtual resources (e.g., weapon, tool), in-environment powers, in-environment skills, in-environment technologies, and/or environment information.

The type of online environment may be a social networking environment, a user-generated content environment, a gaming environment, an educational environment, and/or other types of online environment. The social networking environment may be an online environment for building and maintaining social and/or professional relationships. The user-generated content environment may be an online environment for presentation and/or recognition of user-generated digital images, videos, graphic art, and/or other content. The gaming environment may be an online environment for interaction or engagement with the characters (e.g., player-controlled, non-player-controlled), the virtual items, the content, the reward system, the tasks, the quests, the assignments, the missions, the levels, the chapters, the mini-games, the virtual resources (e.g., weapon, tool), the in-environment powers, the in-environment skills, the in-environment technologies, and/or other aspects of the gaming environment. The education environment may be an online environment for users to learn skills, practice the skills, maintain the skills, teach the skills to other users, and/or other education. In some implementations, an online environment may be more than one of the types of online environments.

The objective of the online environment may include accumulation of virtual items (e.g., points, stars, virtual objects, etc.), social interaction, establishing relationships, conquering opponents, item and/or service exchanges (e.g., purchase, sell, trade, loan, etc.) and/or other objectives. The rules for the online environment, or some, may be distinct for the individual online environments and/or the individual types of the online environments. In some implementations, some of the rules for the online environments may be the same for the individual types of the online environments, for the online environments with the same objectives, and/or other commonalities between online environments.

The characters may be included in the gaming environments, the educational environments, and/or the online environments of the other types. For example, the characters may include an avatar, an animal, a creature, a user representation, and/or other characters. The virtual items, by way of non-limiting example, may include one or more of clothing, pets, transportation units (e.g., aircrafts, motor vehicles, watercrafts, etc.), units, buildings, and/or other virtual items.

The content may include one or more of long videos, short videos, images, literary works (e.g., articles, essays, research papers, etc.), art, and/or other virtual content. The reward system may include points (or variations thereof), currency, badges of recognition, the virtual items, bundles of virtual items, titles, statuses, public presentation of the titles, the statuses, the badges (e.g., on a profile page, on leaderboards), and/or other reward systems for the users.

In some implementations, the environment information may include an instance of a virtual space, a location in the virtual space (e.g., the location from which the view is taken, the location the view depicts, and/or other locations), a zoom ratio, a dimensionality of objects, a point-of-view, and/or view parameters. One or more of the view parameters may be selectable by the user. The instance of the virtual space (e.g., in the gaming environment) may comprise a simulated space that is accessible by users via clients (e.g., client computing platform(s) 104) that present the views of the virtual space to a user. In some implementations, the simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial section of the space. In some instances, the topography may describe a volume with one or more bodies positioned therein (e.g., a simulation of gravity-deprived space with one or more celestial bodies positioned therein). The instance may be executed by computer components of provider server(s) 120 synchronously, asynchronously, and/or semi-synchronously.

In some implementations, the environment information may include which environment features that comprise the environment information are most prevalent for the individual clusters and/or subclusters and thus resonate with the users of such clusters. The most prevalent environment features may be the environment features that are most frequently present in the online environments of the users included in the clusters and/or subclusters relative to other ones of the environment features. In some implementations, the most prevalent environment features may be the environment features that are associated with the psychological parameter values that the users of the clusters and/or subclusters are identified based on. In some implementations, the environment features may be pre-associated by an administrative user (e.g., system creator, psychologist, etc.) and/or determined.

In some implementations, environment obtaining component 110 may be configured to determine the environment features that are most prevalent for the individual clusters and/or subclusters. In some implementations, the determination of the environment features may be based on machine-learning techniques and the psychological parameter values to the psychological parameters that the users of the clusters and/or subclusters are identified based on.

In some implementations, determining the environment features that are most prevalent may include identifying correlations between an environment feature and one or more of the psychological parameter values to one of the psychological parameters (e.g., a range of psychological parameter values for a first psychological parameter), identifying correlations between an environment feature and one or more of the psychological parameters and psychological parameter values thereof (e.g., a first environment feature correlated with a second and third psychological parameter and values thereof), and/or other determinations. Such correlations may be included as the environment information.

Performance obtaining component 112 may be configured to obtain performance information that characterizes the performances of user behavior patterns within the online environment by the users of individual ones of the subclusters. The user behavior patterns may include actions performed by the users. In some implementations, the performance information may be responsive to the online environments of the users and thus the environment information thereof. As such, the performance information may indicate whether the environment features that comprise the environment information particularly resonate with the users. In some implementations, performance obtaining component 112 may be configured to obtain the performance information from one or more of the various storage. In some implementations, the performance information may be obtained from provider server(s) 120 of the individual online environments.

By way of non-limiting example, the user behavior patterns may include individual actions, sets of actions, ordered sets of actions, and/or multiple of the individual actions, the sets of actions, and the ordered set of actions. By way of non-limiting example, the actions may include one or more of a purchase, a sale, a trade, interactions with other users, interactions with the content, a download of particular ones of the content, a post of the content, initiation of the tasks, completion of the tasks, failure of the tasks, uncompletion of the tasks, formation of alliances by the users, a selection of a user interface element, communication of the users with particular users, and/or other actions.

In some implementations, the purchases, sales, and/or trades may be of the content or related to the content and/or the virtual items. The interactions with the content may include sharing the content and/or the virtual items, liking the content and/or the virtual items, saving the content and/or the virtual items, posting the content and/or the virtual items, and/or interactions with the content and/or the virtual items. In some implementations, the tasks may be provided by provider server(s) 120. The communication of the users may include one or more of textual chat, instant messages, private messages, voice communications, video communications, and/or other communications. In some implementations, the communication between the users may be via the provider server(s) 120.

The performance information may characterize performances of the user behavior patterns by the individual users within the online game. The performance information may include counts of the user behavior patterns, time information of the user behavior patterns, occurrence of the user behavior patterns, duration of the user behavior patterns, a time period over which the user behavior patterns occurred (e.g., over one week, over one month, over 100 hours, etc.), overall time spent on the individual online environment performing the user behavior patterns, time of a session on the individual online environment performing the user behavior patterns, and/or other performance information. The time information may include, by way of non-limiting example, time of day of the user behavior patterns, day of the week of the user behavior patterns, date of the user behavior patterns, successiveness of the user behavior patterns, whether it the user behavior patterns are a reaction, and/or other time information.

Response action determination component 114 may be configured to determine response actions for implementation by provider server(s) 120 of the online environment based on the individual subclusters, the performance information, the environment information, impact information, and/or other information. By way of non-limiting example, the response actions may include one or more of offering one or more promotions, offering one or more special events, offering limited access to the special events (e.g., only 50 users may access), providing recommendations, providing suggestions, adjusting a difficulty setting, preventing access to the online environment, increasing fees or prices, decreasing the fees or prices, providing rewards, providing less of the rewards, providing public recognition (e.g., leaderboards), presentation of particular virtual content related to the individual online environments, and/or other response actions. Response action determination component 114, or system 100, determining the response actions may alleviate creators, managers, administrators, and/or other individuals associated with provider server(s) 120 from manually determining changes, updates, or adaptations for their online environments tailored to particular users (i.e., subclusters) and thus improve the particular users' experience with the online environments.

The promotions may include a discount on the virtual items and/or services or particular ones thereof, bundles of the virtual items and/or services for purchase, a rebate, limited time offer of particular virtual items and/or services, and/or other promotions. The special events may include in-person or virtual music events, art events, social events, informational seminars, gaming events, conventions, and/or other special events. The limited access to the special events may be offered based on first-come-first-serve, randomized selection, the reward system of the online environment (e.g., users with particular recognitions, status, and/or rewards), age, highest bids, highest donations, and/or other information. The recommendations may advise the users to perform one or more of the actions and/or other actions. The suggestions may include particular ideas, plans, and/or strategies for the users to consider executing, following, and/or is determined they will enjoy. The adjustment to the difficulty setting may adjust how challenging one or more aspects of the online environment are (e.g., in the gaming environment). The prevention access to the online environment may be indefinitely or for a limited time. In some implementations, the prevention of access may be based on the performance information and/or other information.

The increases and decreases to fees and/or prices may be indefinitely or for a limited time. The fees and/or prices may be for the virtual items, the services, memberships, and/or other items offered by the online environments. The rewards provided in response to the performances of the user behavior patterns, for example, may be increased or decreased per instance of dispersal (e.g., 10 points instead of 5 points for every $1 spent). The public recognition may be provided for more or less for the performances of user behavior patterns or particular ones thereof. The presentation of particular virtual content related to the individual online environments may be new virtual content, previous removed virtual content, user-generated virtual content, and/or other virtual content.

Response action determination component 114 may be configured to transmit the response actions to respective provider server(s) 120 for implementation. In some implementations, some or all of the response actions may be implemented immediately. In some implementations, some or all of the response actions may be implemented during a particular time of day (e.g., during offline hours of 12 AM-4 AM). In some implementations, some or all of the response actions may be implemented responsive to user input that approves of the response actions (e.g., from the administrator of the online environment). In some implementations, upon multiple response actions being transmitted to provider server(s) 120, some of the multiple response actions may be approved via the user input and some of the multiple response actions may be denied via the user input. In some implementations, response action determination component 114 may be configured to implement the response actions for provider server(s) 120.

Impact information obtaining component 116 may be configured to obtain, from provider server(s) 120, impact information and/or other information. The impact information may characterize an impact of the response actions implemented for the individual subclusters on the individual online environments. The impact information may include revenue information, engagement information, and/or information. The impact information and/or information may be related to the subclusters of users for which the response actions were implemented for. In some implementations, the impact information and/or information may be related to all the users of the individual online environments and all the response actions implemented for the individual subclusters. The revenue information may include an amount that revenue of the online environments changed (i.e., increased, decreased, remained the same) subsequent to the implementation of the response actions, the rate of change in the revenue, a period of time over which the revenue changed, the individual response actions that contributed to the change in the revenue, what aspects of the online environment that the changes in the revenue arise from (e.g., sales of virtual items, sales of physical items, memberships to the online environment, etc.), and/or other revenue information.

The engagement information may include an amount that engagement by the users with the individual online environments changed (i.e., increased, decreased, remained the same), particular virtual content, virtual items, and/or services that engagement by the users has changed for, particular performance information for the users that contributed to the change in the amount of engagement, and/or other information. For example, the particular performance information may include the actions, the order of the actions, and/or other information that comprises engagement with the online environments and thus contributes to the change in the amount of engagement.

Correlation determination component 118 may be configured to determine correlations between the response actions implemented and the psychological parameter values of the individual subclusters. The correlations may define which of the response actions cause change in the psychological parameter values of the individual subclusters. Change in the psychological parameter values may include a stronger presence of one or more of the psychological parameter values that the subclusters are based on (e.g., increase in psychological parameter value), a weaker presence of one or more of the psychological parameter values that the subclusters are based on (e.g., decrease in psychological parameter value), a stronger presence of one or more of the psychological parameter values that the subclusters are not based on, a weaker presence of one or more of the psychological parameter values that the subclusters are not based on, and/or other changes in psychological parameter values.

The correlations may be determined by Pearson correlation coefficient formula, linear correlation coefficient formula, sample correlation coefficient formula, population correlation coefficient formula, machine learning, and/or other formulas to determine the correlations. It will be appreciated that the description herein of “correlations” between psychological parameters and response actions which are positively correlated is not intended to be limiting, and that negative correlations between psychological parameters and response actions are also contemplated, and may be included in the generic “correlations”. The determination of negative correlations may be made in cases where users assigned to a cluster, clusters, a subcluster, or subclusters strongly presenting a psychological parameter avoid or do not strongly engage with a specific response actions implemented (e.g., based on the performance information). Correlation determination component 118 may be configured to store the correlations in electronic storage 128, cloud storage, storage of provider server(s) 120, and/or other storage. In some implementations, correlation determination component 118 may be configured to transmit the correlations to provider server(s) 120 for storage by provider server(s) 120.

In some implementations, response action determination component 114 may be configured to obtain the correlations and/or other information. As such, the determining of the response actions for implementation may be further based on the correlations and/or other information. Thus, upon existing subclusters or new subclusters of users being based on or including presence of the psychological parameter values that are correlated with particular response actions, determining the response actions to implement may be based on the correlations. Subsequently, the response actions may be transmitted to provider server(s) 120 for implementation or may be implemented by response action determination component 114.

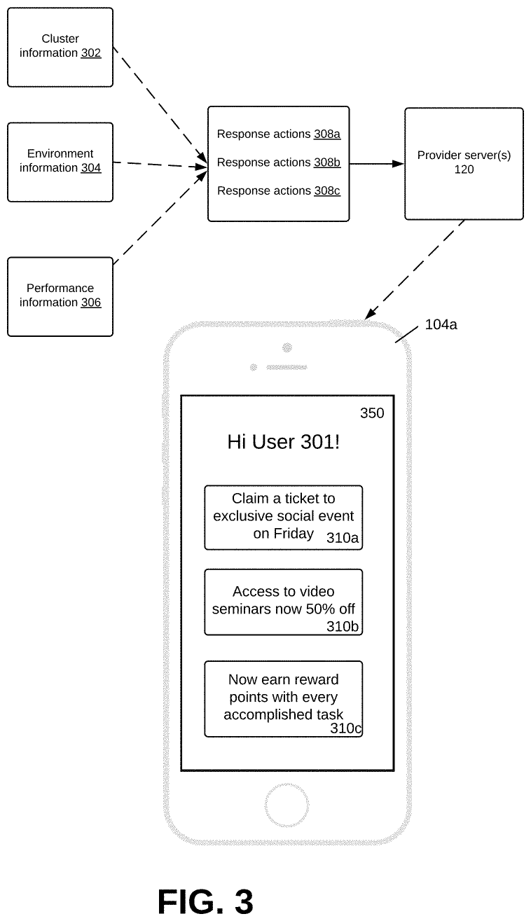

FIG. 3 illustrates an example implementation, in accordance with one or more implementations. FIG. 3 illustrates cluster information 302, environment information 304, and performance information 306 that may be obtained. Cluster information 302, environment information 304, and performance information 306 may be related to the subcluster or cluster that a user 301 is included in, an online environment provided by provider server(s) 120 that user 301 interacts with and that the clusters or subclusters are identified for, and performance of user behavior patterns by user 301 within the online environment, respectively. Based on cluster information 302, environment information 304, and performance information 306, response actions 308a-c may be determined. Subsequently, response actions 308a-c may be transmitted to provider server(s) 120 of the online environment. Provider server(s) 120 may implement response actions 308a-c such that implementations 310a-c, are presented within the online environment for user 301 via graphical user interface 350 of client computing platform 104a associated with user 301.

Referring back to FIG. 1, in some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, and/or 118, and/or other components. Processor(s) 130 may be configured to execute components 108, 110, 112, 114, 116, and/or 118, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, and/or 118 are illustrated in FIG. 1 as being implemented within a single processing unit, in implementations in which processor(s) 130 includes multiple processing units, one or more of components 108, 110, 112, 114, 116, and/or 118 may be implemented remotely from the other components. The description of the functionality provided by the different components 108, 110, 112, 114, 116, and/or 118 described below is for illustrative purposes, and is not intended to be limiting, as any of components 108, 110, 112, 114, 116, and/or 118 may provide more or less functionality than is described. For example, one or more of components 108, 110, 112, 114, 116, and/or 118 may be eliminated, and some or all of its functionality may be provided by other ones of components 108, 110, 112, 114, 116, and/or 118. As another example, processor(s) 130 may be configured to execute one or more additional components that may perform some or all of the functionality attributed below to one of components 108, 110, 112, 114, 116, and/or 118.

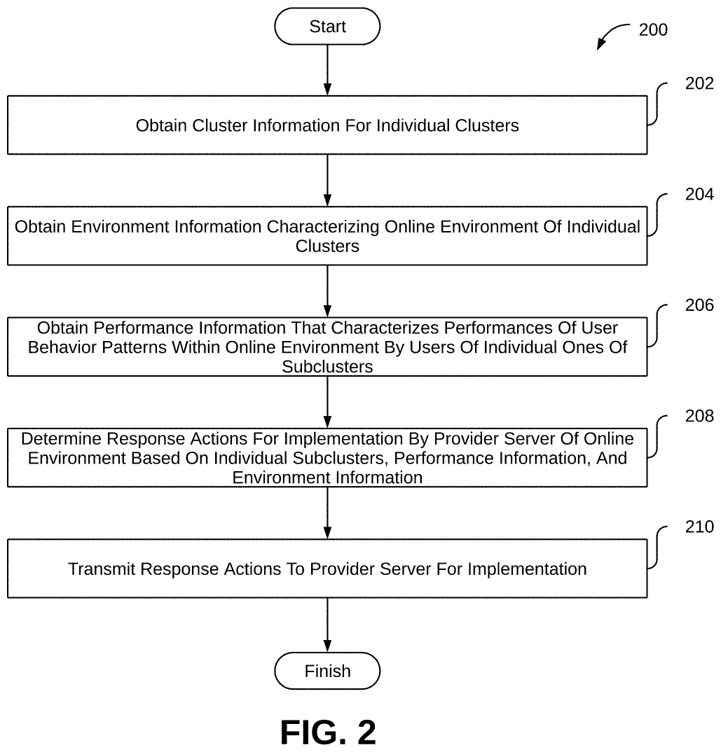

FIG. 2 illustrates a method 200 to provide actionable insights to online environment providers based on an online environment and psychological attributes of users, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining cluster information for individual clusters. The cluster information may characterize the similar psychological parameter values to psychological parameters of users in the same cluster. The cluster information may include subclusters of the users within the individual clusters that have one or more particularly similar psychological parameter values to particular ones of the psychological parameters. Operation 202 may be performed by one or more hardware processors configured by machine-readable instructions including a component that is the same as or similar to cluster obtaining component 108, in accordance with one or more implementations.

An operation 204 may include obtaining environment information characterizing an online environment of the individual clusters. Operation 204 may be performed by one or more hardware processors configured by machine-readable instructions including a component that is the same as or similar to environment obtaining component 110, in accordance with one or more implementations.

An operation 206 may include obtaining performance information that characterizes performances of user behavior patterns within the online environment by the users of individual ones of the subclusters. Operation 206 may be performed by one or more hardware processors configured by machine-readable instructions including a component that is the same as or similar to performance obtaining component 112, in accordance with one or more implementations.

An operation 208 may include determining response actions for implementation by a provider server of the online environment based on the individual subclusters, the performance information, and the environment information. Operation 208 may be performed by one or more hardware processors configured by machine-readable instructions including a component that is the same as or similar to response action determination component 114, in accordance with one or more implementations.

An operation 210 may include transmitting the response actions to the provider server for implementation. Operation 210 may be performed by one or more hardware processors configured by machine-readable instructions including a component that is the same as or similar to response action determination component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to provide actionable insights to online environment providers based on an online environment and psychological attributes of users, the system comprising:
one or more hardware processors configured by machine-readable instructions to:
obtain cluster information for individual clusters, wherein the cluster information characterizes the similar psychological parameter values to psychological parameters of users in the same cluster, wherein the cluster information includes subclusters of the users within the individual clusters that have one or more particularly similar psychological parameter values to particular ones of the psychological parameters;
obtain environment information characterizing an online environment of the individual clusters;
obtain performance information that characterizes performances of user behavior patterns within the online environment by the users of individual ones of the subclusters;
determine response actions for implementation by a provider server of the online environment based on (i) the individual subclusters, (ii) the performance information, and (iii) the environment information; and
transmit the response actions to the provider server for implementation.

2. The system of claim 1, wherein the environment information includes a type of online environment, an objective of the online environment, and/or rules for the online environment.

3. The system of claim 1, wherein the user behavior patterns include actions performed by the users, the user behavior patterns including individual actions, sets of actions, ordered sets of actions, and/or multiple of the individual actions, the sets of actions, and the ordered set of actions.

4. The system of claim 3, wherein the actions include one or more of a purchase, a sale, a trade, interactions with other users, interactions with content, a download of particular content, a post of content, initiation of tasks, completion of the tasks, failure of the tasks, uncompletion of the tasks.

5. The system of claim 1, wherein the response actions include offering a promotion, offering a special event, providing recommendations, preventing access to the online environment, increasing fees or prices, decreasing the fees or prices, providing rewards, and/or providing public recognition.

6. The system of claim 1, wherein the one or more hardware processors are further configured by machine-readable instructions to:
obtain, from the provider server, impact information characterizing an impact of the response actions implemented for the individual subclusters on the online environment;
determine correlations between the response actions implemented with the psychological parameter values of the individual subclusters;
store, in electronic storage, the correlations.

7. The system of claim 6, wherein the one or more hardware processors are further configured by machine-readable instructions to obtain the correlations, wherein the determining of the response actions for implementation are based on the correlations.

8. The system of claim 6, wherein the impact information includes revenue information and/or engagement information.

9. A method to provide actionable insights to online environment providers based on an online environment and psychological attributes of users, the method comprising:
obtaining cluster information for individual clusters, wherein the cluster information characterizes the similar psychological parameter values to psychological parameters of users in the same cluster, wherein the cluster information includes subclusters of the users within the individual clusters that have one or more particularly similar psychological parameter values to particular ones of the psychological parameters;
obtaining environment information characterizing an online environment of the individual clusters;
obtaining performance information that characterizes performances of user behavior patterns within the online environment by the users of individual ones of the subclusters;
determining response actions for implementation by a provider server of the online environment based on (i) the individual subclusters, (ii) the performance information, and (iii) the environment information; and
transmitting the response actions to the provider server for implementation.

10. The method of claim 9, wherein the environment information includes a type of online environment, an objective of the online environment, and/or rules for the online environment.

11. The method of claim 9, wherein the user behavior patterns include actions performed by the users, the user behavior patterns including individual actions, sets of actions, ordered sets of actions, and/or multiple of the individual actions, the sets of actions, and the ordered set of actions.

12. The method of claim 11, wherein the actions include one or more of a purchase, a sale, a trade, interactions with other users, interactions with content, a download of particular content, a post of content, initiation of tasks, completion of the tasks, failure of the tasks, uncompletion of the tasks.

13. The method of claim 9, wherein the response actions include offering a promotion, offering a special event, providing recommendations, preventing access to the online environment, increasing fees or prices, decreasing the fees or prices, providing rewards, and/or providing public recognition.

14. The method of claim 9, further comprising:
obtaining, from the provider server, impact information characterizing an impact of the response actions implemented for the individual subclusters on the online environment;
determining correlations between the response actions implemented with the psychological parameter values of the individual subclusters; and
storing, in electronic storage, the correlations.

15. The method of claim 14, further comprising obtaining the correlations, wherein the determining of the response actions for implementation are based on the correlations.

16. The method of claim 14, wherein the impact information includes revenue information and/or engagement information.
